(19) United States
(12) Patent Application Publication
(10) Pub. No.: US 2013/0054570 A1
(43) Pub. Date: Feb. 28, 2013

(54) DATA SHARING METHODS AND DATA SHARING SYSTEMS

(71) Applicants: Harold Gonzales, Boulder, CO (US); Charles B. Morrey, III, Palo Alto, CA (US)

(72) Inventors: Harold Gonzales, Boulder, CO (US); Charles B. Morrey, III, Palo Alto, CA (US)

(21) Appl. No.: 13/215,830

(22) Filed: Aug. 23, 2011

(51) Int. Cl. G06F 17/30

(52) U.S. Cl. 707/722; 707/769; 707/E17.005; 707/E17.014

(57) ABSTRACT

Data sharing methods and data sharing system are disclosed. An example method includes providing, using a logic circuit, access to a first file associated with a first user to a second user different from the first user; identifying a second file in response to a query submitted by the first user; and prohibiting, using the logic circuit, a third user from accessing the second file.

### BACKGROUND

Enterprises including multiple people, groups, and/or entities, such as a business, benefit from an ability to share information. In the context of electronic systems, sharing information involves enabling a first user to obtain and/or access electronic data associated with a second user.

### BRIEF DESCRIPTION OF THE DRAWINGS

FIG. 1 illustrates first and second user machines in communication with an example data sharing system disclosed herein.

FIG. 2A is a block diagram of an example implementation of the data conditioner of the example data sharing system of FIG. 1.

FIG. 2B illustrates a first example intermediate item generated by the data scanner of FIG. 2A.

FIG. 2C illustrates a second example intermediate item generated by the data scanner of FIG. 2A.

FIG. 2D illustrates a third example intermediate item generated by the data scanner of FIG. 2A.

FIG. 3 is a block diagram of an example implementation of the querior of the example data sharing system of FIG. 1.

FIG. 4 is a block diagram of an example implementation of the sharing manager of the example data sharing system of FIG. 1.

FIG. 5 is a flowchart representative of machine readable instructions that may be executed to implement the example data conditioner of FIGS. 1 and/or 2.

FIG. 6 is a flowchart representative of machine readable instructions that may be executed to implement the example live querior of FIGS. 1 and/or 3.

FIG. 7 is a flowchart representative of machine readable instructions that may be executed to implement the example sharing manager of FIGS. 1 and/or 4.

FIG. 8 is a block diagram of an example processor system capable of executing the example machine readable instructions of FIGS. 5-7 to implement the example data sharing system of FIGS. 1-4.

### DETAILED DESCRIPTION

Example methods, systems, articles of manufacture and apparatus disclosed herein enable a first user to share data with one or more other users by querying a data set spanning across one or more data sources associated with the first user. Data related to results of the quer(ies) are shared by a centralized data sharing system disclosed herein. To enable such queries, example methods, systems, articles of manufacture and apparatus disclosed herein create a queryable corpus of data for each user by aggregating (e.g., retrieving to form a collection) and conditioning (e.g., sorting and/or ranking according to relevancy of terms) data from data source(s) to which the respective user has access.

Example methods, systems, articles of manufacture and apparatus disclosed herein execute queries submitted by the users on the queryable data set as isolated queries and/or live queries. An isolated query executes once on a data set and returns results found in the data set at a time at which the isolated query is executed. In contrast, a live query repeatedly executes on an evolving data set and returns results found in the data set each time the live query is executed (e.g., when the data set changes and/or according to a schedule). Thus, example methods, systems, articles of manufacture and/or apparatus disclosed herein can repeatedly execute a query on a dynamically changing data set (e.g., set(s) of files or documents stored on machine(s) associated with the first user).

Example methods, systems, articles of manufacture and apparatus disclosed herein enable users to share data related to results of the query (e.g., an isolated or live query) with other user(s) by designating the query results as accessible to the other user(s). That is, example methods, systems, articles of manufacture and/or apparatus disclosed herein enable sharing of files meeting one or more search criteria from a data set of a first user (e.g., data files stored on machine(s) associated with the first user) with a second user. For example, the first user may want to share documents including the term ‘ProjectA’ with the second user. In such instances, example methods, systems, articles of manufacture and apparatus disclosed herein execute a query (e.g., once for an isolated query or multiple times for a live query) to locate documents including the term ‘ProjectA’ and, if one or more results are returned from the query, mark the located document(s) as accessible to the second user.

Additionally, example methods, systems, articles of manufacture and apparatus disclosed herein enable users to submit a privacy query to restrict other users from accessing data related to results of the privacy query. That is, example methods, systems, articles of manufacture and apparatus disclosed herein enable a first user to restrict other users from accessing files meeting one or more search criteria from the data set of the first user. For example, the first user may want to prevent other users from accessing documents including the term ‘Family.’ In such instances, example methods, systems, articles of manufacture and apparatus disclosed herein execute a query (e.g., once for an isolated query or multiple times for a live query) to locate documents including the term ‘Family’ and, if one or more results are returned from the query, mark the located document(s) as private. To continue the above example, if a document includes the term ‘ProjectA’ and the term ‘Family,’ example methods, systems, articles of manufacture and apparatus disclosed herein prevent that document from being accessible to the second user. Thus, as described in greater detail below, example methods, systems, articles of manufacture and apparatus disclosed herein combine shared live queries with the privacy live queries to enable a persistent sharing mechanism with the protection of having private data persistently filtered out of the shared data. Previously, systems enabled unrestricted sharing and/or requiring users to hide documents from sharing. However, this requires users to constantly prevent documents from being shared by designating each new and/or modified document as private. Examples disclosed herein advantageously enable sharing while persistently and automatically protecting documents in a changing data set.

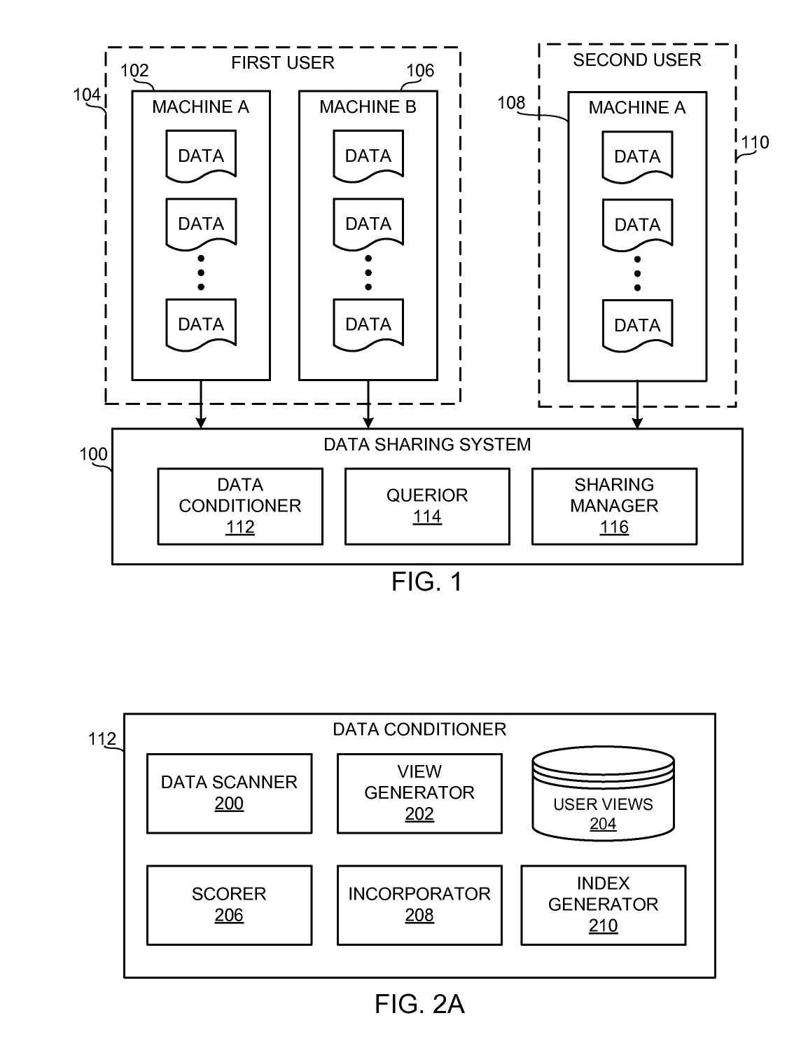

FIG. 1 illustrates an example data sharing system 100 implemented in accordance with the teachings of this disclosure. The example data sharing system 100 of FIG. 1 facilitates querying of data and data sharing among a plurality of user machines. The example data sharing system of FIG. 1 includes a first user machine 102 associated with a first user 104, a second user machine 106 associated with the first user 104, and a third user machine 108 associated with a second user 110. However, the example data sharing system 100 can accommodate any number of user machines associated with any number of users. The first and second users 104 and 110 of FIG. 1 may be members of an enterprise such as, for example, a business, a department or division (e.g., software development), a family, and/or any other type of group that may benefit from sharing data among members. The first machine 102 of the first user 104 may be, for example, a laptop computer and the second machine 106 of the first user 104 may be, for example, a home computer. Similarly, the third user machine 108 of the second user 110 may be any type of computing device capable of storing data.

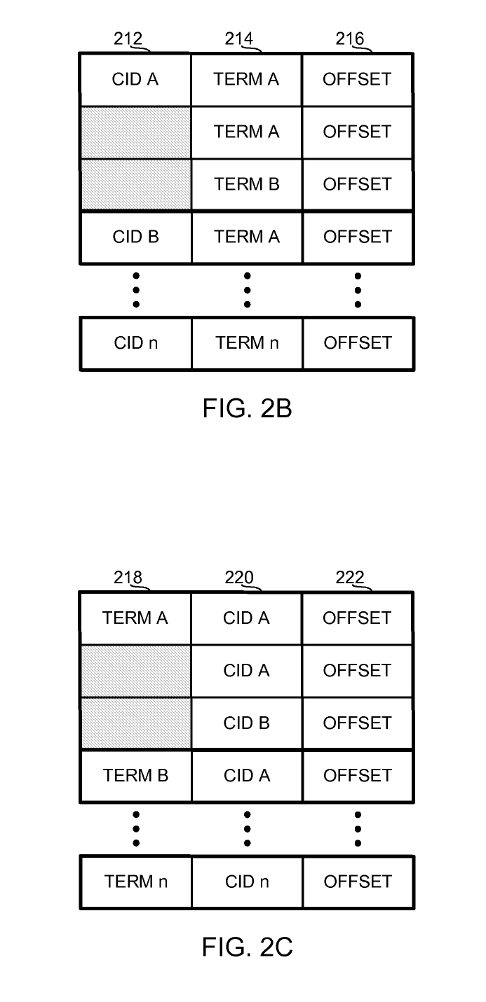

In the illustrated example of FIG. 1, the first, second and third user machines 102, 106, 108 are in communication with the data sharing system 100. Each of the of the user machines 102, 106, 108 stores data such as, for example, files, images, photographs, documents, groups of files and/or documents, etc. As described in greater detail below in connection with FIG. 2, a data conditioner 112 of the example data sharing system 100 of FIG. 1 aggregates and conditions (e.g., sorts and/or ranks according to relevancy of, for example, terms and/or phrases occurring therein) the data stored on the user machines 102, 106, 108 such that the users 104, 110 can query a collection of the data. Thus, the example data conditioner 112 of the example data sharing system 100 of FIG. 1 creates a first queryable data set (sometimes referred to herein as a ‘user view’ or ‘user-specific view’) for the first user 104 including data of the first and second user machines 102 and 106. Further, the example data conditioner 112 creates a second queryable data set for the second user 110 including data of the third user machine 108.

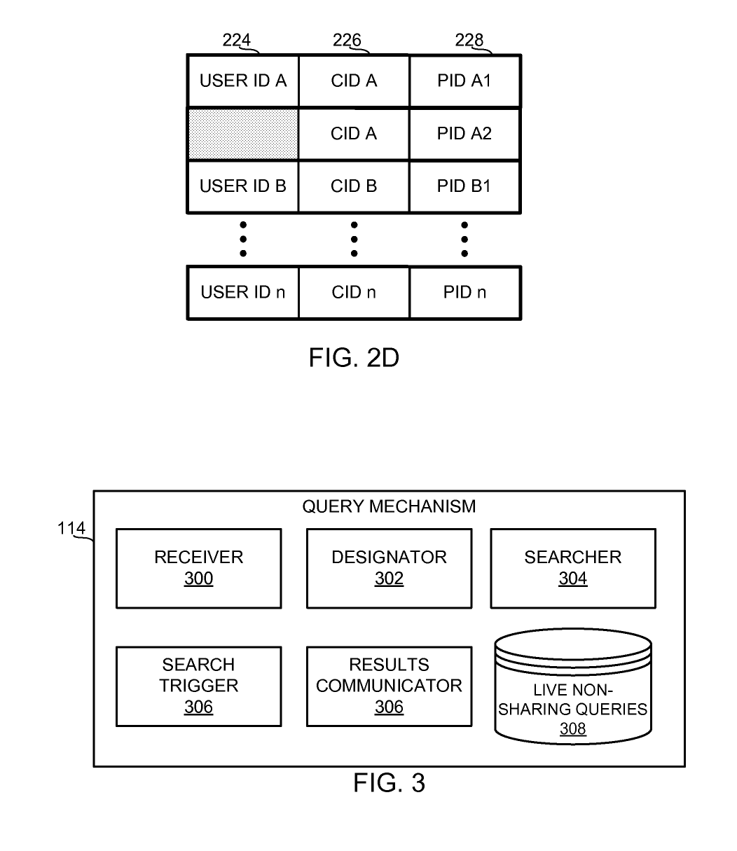

The example data sharing system 100 of FIG. 1 also includes a querior 114 to facilitate isolated and live queries of data sets associated with the users of the data sharing system 100. The example querior 114 of FIG. 1 handles isolated queries submitted by, for example, the first user 104 by searching the conditioned data associated with the first user 104 and returning the results to the first user 104. Alternatively, the first user 104, for example, may submit a live query request. In such instances, the example querior 114 executes the query, stores the criteria (e.g., keywords and/or terms) of the query, and facilitates one or more additional executions of the query at later time(s) (e.g., automatically re-executes the query periodically or a periodically for some period of time and/or for some number of executions). The data set to be queried may be different at the later time(s) (e.g., due to changes to existing portion(s) of the data set, substitutions, and/or additions to the data set) and, thus, results of different executions of the same query may differ. The example querior 114 is described in greater detail below in connection with FIG. 3.

The example data sharing system 100 of FIG. 1 also includes a sharing manager 116. The example sharing manager 116 of FIG. 1 enables users of the data sharing system 100 to share data identified in a query (e.g., an isolated or live query) with one or more other users of the data sharing system 100. When the first user 104 of FIG. 1, for example, submits a query to the data sharing system 100, the first user 104 may indicate that the query is a sharing query and may designate the second user 110 as a target of the sharing request. In such instances, the example sharing manager 116 obtains the results of the query (e.g., data files meeting criteria of the query) and makes the results available to the second user 110. If the submitted query is a live sharing query (as opposed to an isolated sharing query), the example sharing manager 116 facilitates one or more additional execution(s) of the query and, for each execution of each line query, makes the respective results accessible to the second user 110.

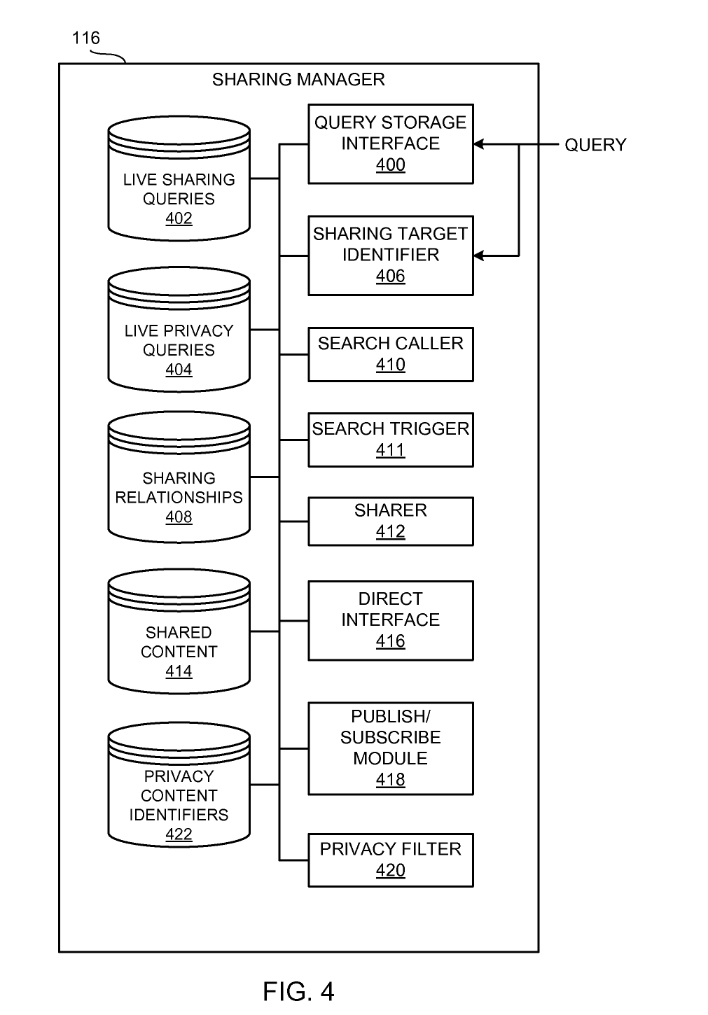

Additionally, the example sharing manager 116 enables users of the data sharing system 100 to prohibit access to some or all data using a privacy query (e.g., which may be either an isolated or live query). When the first user 104, for example, submits a query to the data sharing system 100, the first user 104 may indicate that the query is a privacy query. In such instances, the example sharing manager 116 obtains the results of the query (e.g., data files meeting criteria of the query) and prohibits the second user 110 (or any other user) from accessing the results. The prohibition against access may be with respect to a specific user (e.g., the second user), a set of users or all users as selected by the first user. If the submitted query is a live privacy query (as opposed to an isolated privacy query), the example sharing manager 116 repeatedly filters the data accessible to the second user 110 (and any other user) to exclude private data (e.g., data files meeting the criteria of the privacy query). The example sharing manager 116 of FIG. 1 is described in greater detail below in connection with FIG. 4.

While an example manner of implementing the data sharing system 100 has been illustrated in FIG. 1, one or more of the elements, processes and/or devices illustrated in FIG. 1 may be combined, divided, re-arranged, omitted, eliminated and/or implemented in any other way. Further, the example data conditioner 112, the example querior 114, the example sharing manager 116, and/or, more generally, the example data sharing system 100 of FIG. 1 may be implemented by hardware, software, firmware and/or any combination of hardware, software and/or firmware. Thus, for example, any of the example data conditioner 112, the example querior 114, the example sharing manager 116, and/or, more generally, the example data sharing system 100 of FIG. 1 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended apparatus or system claims are read to cover a purely software and/or firmware implementation, at least one of the example data conditioner 112, the example querior 114, the example sharing manager 116, and/or, more generally, the example data sharing system 100 of FIG. 1 are hereby expressly defined to include a tangible and/or non-transitory computer readable medium such as a physical memory, DVD, CD, etc. storing the software and/or firmware. Further still, the example data sharing system 100 of FIG. 1 may include one or more elements, processes and/or devices in addition to, or instead of, those illustrated in FIG. 1, and/or may include more than one of any or all of the illustrated elements, processes and devices.

FIG. 2A illustrates an example manner of implementing the example data conditioner 112 of FIG. 1. The example data conditioner 112 of FIG. 2A creates a queryable corpus of data for each user of the data sharing system 100. For example, the data conditioner 112 creates a first queryable corpus corresponding to the first user 104 including files stored on the first and second user machines 102, 106. Similarly, the data conditioner 112 creates a second queryable corpus corresponding to the second user 110 including files stored on the third user machine 108. As described in detail below, for each user, the example data conditioner 112 of FIG. 2A uses metadata to create a series of intermediate items representative of the data files stored on the user machines 102, 106, 108. Using the intermediate items, the example data conditioner 112 of FIG. 2A generates a table for each queryable corpus. In the illustrated example, the table includes terms found in the content of the queryable corpus and statistics related to each term, such as a relevance score of each data file in which a respective term is found. In other words, for a first data file of the queryable corpus of the first user 104, the table generated for the first user 104 includes a relevance ranking for each term found in the first data file. Thus, assuming the term ‘ProjectA’ is found in the first data file, the corresponding table includes a relevance ranking for the first data file for the term ‘ProjectA’ depending on, for example, how many times and/or where ‘ProjectA’ occurs in the first data file.

The example data conditioner 112 of FIG. 2A includes a data scanner 200 to scan or analyze data files stored on machines interacting with the data sharing system 100. In the illustrated example, the data scanner 200 scans the first and second user machines 102 and 106 of the first user 104 and the third user machine 108 of the second user 110 to generate global intermediate items including metadata indicative of aspects of the content found on machines interacting with the data sharing system 100. In the illustrated example of FIG. 2A, the data scanner 200 is implemented by a LazyBase pipeline in connection with metadata storage engine. The LazyBase pipeline, in conjunction with the storage engine, generates reverse posting lists in DataSeries files indicative of aspects of the scanned data. For example, the data scanner 200 of FIG. 2A generates a global reverse_posting_list_by_cid item, which is a DataSeries file including a table of rows each having a CID (content identifier) that uniquely identifies one of the data files scanned by the data scanner 200, a term found in the data file, and an offset at which that term occurs within the data file. Thus, the global reverse_posting_list_by_cid item includes a plurality of entries for a scanned data file, each corresponding to a term found in the scanned data file. FIG. 2B illustrates an example global reverse_posting_list_by_cid item generated by the example data scanner 200. A first column 212 of the example global reverse_posting_list_by_cid item of FIG. 2B includes CIDs each corresponding to a data file. In the illustrated example, the global reverse_posting_list_by_cid item includes information corresponding to a first data file (CID A) and a second data file (CID B). A second column 214 of the example global reverse_posting_list_by_cid item of FIG. 2B includes terms found in each of the files identified in the first column 212. In the illustrated example, the global reverse_posting_list_by_cid item includes information corresponding to a first term (TERM A) and a second term (TERM B) for the first data file (CID A). The first term (TERM A) also appears in the second data file (CID B). A third column 216 of the example global reverse_posting_list_by_cid item of FIG. 2B includes offsets at which the corresponding term of the second column 214 is found in the data file identified in the first column 212. The global reverse_posting_list_by_cid item of the illustrated example is sorted by CID and, thus, the data files. The example global reverse_posting_list_by_cid item of FIG. 2B is shown for purposes of illustration and more complex and/or detailed tables are possible.

The example data scanner 200 of FIG. 2A also generates a global reverse_posting_list_by_term item, which contains the same information of term occurrences as the reverse_posting_list_by_cid item, but is sorted by term. As described below, the sorted reverse_posting_list_by_term item is useful in scoring or ranking the scanned documents. FIG. 2C illustrates an example global reverse_posting_list_by_term item generated by the example data scanner 200. The example global reverse_posting_list_by_term item of FIG. 2C includes the information shown in the example FIG. 2B, but is sorted by term. In particular, a first column 218 of the example global reverse_posting_list_by_term item of FIG. 2C, by which the item is sorted, includes terms found in the data files. A second column 220 of the example global reverse_posting_list_by_term item of FIG. 2C includes CIDs of the corresponding data files. A third column 222 of the example global reverse_posting_list_by_term item of FIG. 2C includes offsets at which the corresponding term of the first column 218 is found in the data file identified in the second column 220. The global reverse_posting_list_by_term item of the illustrated example is sorted by term. The example global reverse_posting_list_by_term item of FIG. 2C is shown for purposes of illustration and more complex and/or detailed tables are possible.

The example data scanner 200 of FIG. 2A also generates a global pid_by_cid_with_names item, which contains mappings from a unique CID of a data file to a PID (path based identifier), which differentiates instances of the same data file stored in different places (e.g., different user machines). The global pid_by_cid_with_names item also includes identifiers indicative of an identity of the corresponding user and the corresponding machine on which the data file is stored. That is, entries of the global pid_by_cid_with_names item identify to which of the first or second users 104 or 110 a corresponding data file belongs. FIG. 2D illustrates an example global pid_by_cid_with_names item generated by the example data scanner 200. A first column 224 of the example pid_by_cid_with_names item of FIG. 2D includes user identifiers or names (e.g., corresponding to the first or second user 104, 110 of FIG. 1). A second column 226 of the example global pid_by_cid_with_names item of FIG. 2D includes CIDs of data files of the respective user identified in the corresponding entry of the first column 224. A third column of the example global pid_by_cid_with_names item of FIG. 2D includes PIDs identifying a machine on which the respective data file of the second column 226 is found (e.g., is stored in local memory). The global pid_by_cid_with_names item is sorted by cid and, thus, the data files. The example global pid_by_cid_with_names item of FIG. 2D is shown for purposes of illustration and more complex and/or detailed tables are possible.

The data received by the example data sharing system 100 of FIG. 1 from the users forms a global view, which is defined by, for example, the global reverse_posting_list_by_cid item, the global reverse_posting_list_by_term item, and/or the global pid_by_cid_with_names item. To define a portion of the global view that can be queried by a user, the example data conditioner 112 of FIG. 2A creates a user-specific view for that particular user. To create the user-specific views, the example data conditioner 112 of FIG. 2A includes a view generator 202. In the illustrated example of FIG. 2A, the view generator 202 analyzes the global pid_by_cid_with_names item generated by the data scanner 200 and extracts rows that contain CIDs and PIDs associated with data files belonging to a user. In other words, the view generator 202 identifies which of the data files of the data sharing system 100 are queryable by that user. Thus, for the first user 104 of FIG. 1, the example view generator 202 of FIG. 2A extracts rows of the global pid_by_cid_with_names item corresponding to content belonging to the first user 104 (e.g., content from the first and/or second user machines 102, 106). In reference to FIG. 2D, the view generator 202 identifies data files belonging to the first user 104 by analyzing the first column 224 including identifying user information associated with data files identified in the second column 226 and/or the third column 228. Similarly, for the second user 110, the example view generator 202 of FIG. 2A extracts rows of the global pid_by_cid_with_names items corresponding to content belonging to the second user 110 (e.g., content from the third user machines 108). Accordingly, the example view generator 202 extracts rows for each user including CIDs that represent content that is queryable by a corresponding user.

For each user, the example view generator 202 then compares the CIDs extracted from the global pid_by_cid_with_names item to the global reverse_posting_list_by_cid item and the global reverse_posting_list_by_term item to identify the CIDs in those global items. As described above, the global reverse_posting_list_by_cid item includes a plurality of rows, each having a CID corresponding to a data file, a term found in the data file, and position(s) (e.g., offset(s)) of that term within the data file. The global reverse_posting_list_by_term item includes the same information as the global reverse_posting_list_by_cid item except the reverse_posting_list_by_term item is sorted by term (instead of by CID). The example view generator 202 extracts the rows of the global reverse_posting_list_by_cid item and the rows global reverse_posting_list_by_term item having a CID extracted from the global pid_by_cid_with_names item as described above. That is, the example view generator 202 obtains entries of the global reverse posting list items that correspond to data files of a respective user. Thus, for the first user 104, the view generator 202 compares CIDs extracted from the global pid_by_cid_with_names item (e.g., of FIG. 2D) to the CIDs of the global reverse_posting_list_by_cid item (e.g., of FIG. 2B) and the global reverse_posting_list_by_term item (e.g., of FIG. 2C) and extracts matching rows from the global reverse_posting_list_by_cid item and the rows global reverse_posting_list_by_term item. The example view generator 202 stores the rows extracted from the global reverse_posting_list_by_cid item and the global reverse_posting_list_by_term item in a first queryable table associated with the first user 104. The first queryable table is designated as a view for the first user 104 and is stored in a user view database 204. Similarly, for the second user 110, the view generator 202 compares CIDs extracted from the global pid_by_cid_with_names item (e.g., of FIG. 2D) to the CIDs of the global reverse_posting_list_by_cid item and the global reverse_posting_list_by_term item and extracts matching rows from the global reverse_posting_list_by_cid item and the global reverse_posting_list_by_term item. The example view generator 202 stores the rows extracted from the global reverse_posting_list_by_cid item and/or the global reverse_posting_list_by_term item in a second queryable table associated with the second user 110. The second queryable table is designated as a view for the second user 110 and is stored in the user view database 204. Accordingly, the example user view database 204 of FIG. 2A includes a view for each user defining the content that a respective user can query, the terms or keywords in each piece of content, and position(s) of the terms in the corresponding piece of content.

To determine term relevancy rankings for each data file in a user view, the example data conditioner 112 of FIG. 2A includes a scorer 206. In the illustrated example of FIG. 2A, the scorer 206 executes a term-frequency inverse-document-frequency (TF-IDF) function for each term of a data file. The TF-IDF operation includes several stages. First, the TF-IDF function computes a term frequency for a first term in a data file by dividing a number of instances of the first term by a total number of terms in the file, thereby normalizing the term frequency for document length. In the illustrated example, the scorer 206 obtains the number of instances of the first term and the document length by scanning the reverse_posting_list_by_cid item generated by the view generator 202. In particular, the example scorer 206 of FIG. 2A accumulates the term count for each CID of the reverse_posting_list_by_cid item. Second, the TF-IDF function computes an inverse document frequency, which is the reciprocal of the number of documents in the user view including the first term (e.g., document frequency) in relation to the total number of files in the user view. In the illustrated example, the scorer 206 obtains the document frequency using the reverse_posting_list_by_term item generated by the view generator 206. In particular, for the number of documents in the user view including the first term, the example scorer 206 of FIG. 2A accumulates a CID count for the first term as it occurs in the reverse_posting_list_by_term item. The example scorer 206 of FIG. 2A obtains the total number of files in the user view by scanning the reverse_posting_list_by_term item or the reverse_posting_list_by_cid item and accumulating a total number of CIDs. The TF-IDF multiplies the term frequency by the inverse document frequency to arrive at the TF-IDF score for the first term. In addition to the first term, a similar process is executed for every term of the user view or corpus of viewable data.

In the illustrated example of FIG. 2A, an incorporator 208 incorporates the TF-IDF score calculated by the scorer 206 for each term occurring in the corresponding user view into that entry of the user view database 204. For example, as described above, the user view database 204 includes the first table associated with the first user 104 that defines the queryable corpus of data for the first user 104. The first table associated with the first user 104 includes a plurality of entries, each including a term, a CID, a PID, a user machine identifier, and/or a user identifier. The example incorporator 208 adds the TF-IDF score calculated by the scorer 206 for each term to the corresponding entries of the first table associated with the first user 104. Similarly, the example incorporator 208 adds the TF-IDF scores for terms occurring in the queryable corpus of the second user 110 to the corresponding entries using such terms in a second table associated with second user 110 in the user views database 204. Additional or alternative functions and/or methods may be utilized to score or rank the data files of the user view database 204.

The user view database 204 includes a plurality of tables each defining a queryable corpus of data for a corresponding user. Each of the tables (e.g., generated as described above in connection with FIGS. 2B-2D) includes identifying information (e.g., CIDs and/or PIDs) for each file of the queryable corpus, terms occurring in each file of the queryable corpus, and statistics (e.g., a TF-IDF score) for each file of the queryable corpus. The example data conditioner 112 of FIG. 2A also includes an index generator 210. In some examples, the index generator 210 generates one or more indexes for the data stored in the user view database 204 to facilitate searching of the user view database 204. That is, the example index generator 210 generates index(es) that a search can utilize to more quickly locate term(s).

While an example manner of implementing the data conditioner 112 of FIG. 1 has been illustrated in FIG. 2A, one or more of the elements, processes and/or devices illustrated in FIG. 2A may be combined, divided, re-arranged, omitted, eliminated and/or implemented in any other way. Further, the example data scanner 200, the example view generator 202, the example scorer 206, the example incorporator 208, the example index generator 210, and/or, more generally, the example data conditioner 112 of FIG. 2A may be implemented by hardware, software, firmware and/or any combination of hardware, software and/or firmware. Thus, for example, any of the example data scanner 200, the example view generator 202, the example scorer 206, the example incorporator 208, the example index generator 210, and/or, more generally, the example data conditioner 112 of FIG. 2A could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended apparatus or system claims are read to cover a purely software and/or firmware implementation, at least one of the example data scanner 200, the example view generator 202, the example scorer 206, the example incorporator 208, the example index generator 210, and/or, more generally, the example data conditioner 112 of FIG. 2A are hereby expressly defined to include a tangible and/or non-transitory computer readable medium such as a physical memory, DVD, CD, etc. storing the software and/or firmware. Further still, the example data conditioner 112 of FIG. A2 may include one or more elements, processes and/or devices in addition to, or instead of, those illustrated in FIG. 2A, and/or may include more than one of any or all of the illustrated elements, processes and devices.

FIG. 3 is a block diagram of an example implementation of the querior 114 of FIG. 1. The example querior 114 of FIG. 3 includes a receiver 300 to receive one or more terms and/or phrases that form quer(ies) from user(s) of the data sharing system 100. For example, the first user 104 may convey term(s) and/or phrase(s) to the querior 114 to attempt to locate files in the queryable corpus of data associated with the first user 104 (e.g., the data stored on the first and second user machines 102 and 106). The example receiver 300 of FIG. 3 is an interface to enable the querior 114 to receive such queries. In some examples, the receiver 300 implements a user interface presentable to the users to enable submission of the queries.

As described above, in some examples the first user 104 can indicate that the query is to be an isolated query, which is executed once, or a live query, which is executed a plurality of times (e.g., periodically and/or a periodically) in response to, for example, a trigger event and/or reaching a scheduled time to execute the query. Such indications made by the submitter of a query are conveyed to the receiver 300 in connection with the term(s) and/or phrase(s) of the query. The example querior 114 of FIG. 3 includes a designator 302 to interpret the indications and to designate a received query as isolated or live according to the interpretation. Additionally, the first user 104 can indicate that the query is a sharing query or a privacy query. The example designator 302 also interprets the sharing/privacy indications and, in such instances, designates the received query as a sharing query or privacy query. Thus, a received query can be, for example, an isolated non-sharing query, a live non-sharing query, an isolated sharing query, a live sharing query, an isolated privacy query, or a live privacy query. The example designator 302 of FIG. 3 conveys data (e.g., the query and a sharing target(s) of the query) to the sharing manager 116 described in FIG. 4 when a query is determined to be a sharing query or a privacy query.

When the example designator 302 of FIG. 3 determines that a query received from the first user 104 is an isolated non-sharing query, the designator 302 marks the query as such and instructs a searcher 304 to perform a single execution of the query on the first table associated with the first user 104 of the user views database 206. The example searcher 304 of FIG. 3 employs any suitable technique, algorithm, method, etc to search for data files including the term(s) and/or phrase(s) of the received query. In some examples, the example searcher 306 uses the index generator 210 to facilitate or assist the searching process. Thus, the searcher 304 searches the queryable corpus of data provided by the example data conditioner 112 corresponding to the query submitter. The example searcher 304 obtains search results according to, for example, the relevancy rankings stored in association with the data files of the user views database 204. The example searcher 304 conveys the search results of the isolated non-sharing query to a results communicator 306, which conveys the search results to the first user 104. The example results communicator 306 conveys the search results to the first user 104 using any suitable communication technique and/or device (e.g., email, on a user interface implemented in connection with the data sharing system 100, etc.).

In some examples, the first user 104 informs the example results communicator 306 of a preferred format and/or address via which the results are to be communicated to the first user 104. When the query is designated as an isolated query, the example searcher 304 does not repeat the query (unless the first user 104 requests the same query again at a later time). Thus, in the illustrated example of FIG. 3, the isolated query is not maintained (e.g., stored for a substantial period of time) at the querior 114. However, in some examples, isolated queries can be stored indefinitely (e.g., for re-use, for record keeping purposes or to implement an option to later designate the query as a live, sharing, or privacy query).

When the example designator 302 determines that a received query is a live non-sharing query, the designator 302 marks the query as a live non-sharing query and instructs the searcher 304 to perform an initial execution of the query. The example querior 114 includes a non-sharing live query database 308 to store the non-sharing live queries that are to be repeated. The example searcher 304 is instructed to repeat the search defined by the live query at later times defined by a search trigger 305. The example search trigger 305 of FIG. 3 detects events and/or times that cause the live query to be repeated. Example triggering events for the live queries of the database 308 include receipt of new data in the corresponding queryable corpus of data in the user view database 204, occurrence of a scheduled time (e.g., according to a schedule stored in connection with the search trigger 305), request of the corresponding user, etc.

Each time a live query is to be executed, the example searcher 304 searches the first table associated with the first user 104 of the user view database 206 for the term(s) and/or phrase(s) of the received query. The example searcher 304 of FIG. 3 uses any suitable technique, algorithm, method, etc. to identify data files including the term(s) and/or phrase(s) of the query. The example searcher 304 obtains search results according to, for example, the relevancy rankings stored in association with the data files of the user view database 204. In some examples, the searcher 304 conveys the search results to the results communicator 306 for each execution of the live queries. The example communicator 306 communicates the search results to the corresponding user. Additionally or alternatively, the search results may be conveyed to the user view database 204, which forms the search results into a sub-corpus of data to be queried again at a later time. That is, the example user view database 204 may store the results of a search and the searcher 304 may be instructed to run a second query on the corresponding sub-corpus of data. This enables the user to refine search results if a two-tiered search is desired.

When the example designator 302 of FIG. 3 determines that a received query is a sharing query or a privacy query, the designator 302 marks the query as a sharing query or a privacy query, and as isolated or live, and conveys the query to the sharing manager 116 described below in connection with FIG. 4.

While an example manner of implementing the querior 114 of FIG. 1 has been illustrated in FIG. 3, one or more of the elements, processes and/or devices illustrated in FIG. 3 may be combined, divided, re-arranged, omitted, eliminated and/or implemented in any other way. Further, the example receiver 300, the example designator 302, the example searcher 304, the example results communicator 306, and/or, more generally, the example querior 114 of FIG. 3 may be implemented by hardware, software, firmware and/or any combination of hardware, software and/or firmware. Thus, for example, any of the example receiver 300, the example designator 302, the example searcher 304, the example results communicator 306, and/or, more generally, the example querior 114 of FIG. 3 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended apparatus or system claims are read to cover a purely software and/or firmware implementation, at least one of the example receiver 300, the example designator 302, the example searcher 304, the example results communicator 306, and/or, more generally, the example querior 114 of FIG. 3 are hereby expressly defined to include a tangible and/or non-transitory computer readable medium such as a physical memory, DVD, CD, etc. storing the software and/or firmware. Further still, the example querior 114 of FIG. 3 may include one or more elements, processes and/or devices in addition to, or instead of, those illustrated in FIG. 3, and/or may include more than one of any or all of the illustrated elements, processes and devices.

FIG. 4 is a block diagram of an example implementation of the sharing manager 116 of FIG. 1. The example sharing manager 116 of FIG. 4 receives a query from the example querior 114 of FIG. 3 when the designator 302 of the querior 114 determines that the query is a sharing query or a privacy query. As described above, the designator 302 of FIG. 3 conveys the query to the sharing manager 116 with an indication or marking indicative of whether the query is a sharing query or a privacy query, and whether the query is an isolated query or a live query. The example sharing manager 116 includes a query storage interface 400 to interpret the markings of the received query. In other words, the example query storage interface 400 determines whether the received query is an isolated sharing query, a live sharing query, an isolated privacy query, or a live privacy query. To accommodate the live queries, which are repeatedly executed, the example sharing manager 116 of FIG. 4 includes a live sharing query database 402 and a live privacy query database 404. The example query storage interface 400 facilitates storage of live queries in the appropriate one of the databases 402 or 404. Further, the example query storage interface 400 identifies a submitter of the query and stores identifying information associated with the submitter in the appropriate one of the databases 402 or 404.

The example sharing manager 116 of FIG. 4 includes a sharing target identifier 406 to identify user(s) designated in the received query as target(s) of sharing when the received query is a sharing query. With reference to FIG. 1, when the first user 104 wants to share data stored on the first and/or second user machines 102 and/or 106 (e.g., the queryable corpus associated with the first user 104 in the user view database 204 of FIG. 2) with the second user 110, the first user 104 submits a sharing query to the data sharing system 100 and designates the second user 110 as a sharing target. The first user 104 can designate additional or alternative users and/or groups of users as sharing targets. The example sharing target identifier 406 of FIG. 4 interprets the designation(s) associated with received query and establishes a sharing relationship between the submitted user (e.g., the first user 104 in the above example) and the sharing target(s) (e.g., the second user 110 in the above example). When the received query is a live query, which is to be repeated, the example sharing target identifier 406 stores the relationship(s) in association with the received query in a sharing relationship database 408. In the illustrated example of FIG. 4, the sharing relationship database 408 includes entries that corresponding with entries of the live sharing query database 402. For example, when the received query is one submitted by the first user 104 designating the second user 110 as the sharing target, the query storage interface 400 stores the query in a first address space of the live sharing query database 402 and the sharing target identifier 406 stores a relationship between the first user 104 and the second user 110 in a first address space of the sharing relationship database 408. The first address space of the live sharing query database 402 and the first address space of the sharing relationship database 408 are tied together via, for example, pointers and/or tags.

The example sharing manager 116 of FIG. 4 includes a search caller 410 to facilitate a search of the queryable corpus of data corresponding to a submitter of the received query. The example search caller 410 is triggered to facilitate a search by a search trigger 411 that operates in a similar manner and/or in conjunction with the search trigger 305 of FIG. 3. For example, the search trigger 411 of FIG. 4 may trigger the search caller 410 in response to new data arriving in a table of the user view database 204 of FIG. 2, according to a schedule, and/or at the request of one or more users. In the illustrated example, the search caller 410 of FIG. 4 accesses the live sharing query database 402 or the live privacy query database 404, depending on a type of the instant query, to obtain information that is passed to the searcher 304 of the querior of FIG. 3 as, for example, values of a function call.

The searcher 304 performs a search of a corpus of data in the user view database 204 corresponding to the user who submitted the query. In the illustrated example, the returned results are received by the search caller 410 and include content identifiers (CIDs) associated with the results and/or the data files of the results. Thus, the example search caller 410 receives data files and/or CID(s) associated with the data file(s) of the query submitter meeting certain criteria (e.g., term(s) and/or phrases of the query). When the query is a sharing query, the search caller 410 conveys the search results to a sharer 412. The example sharer 412 of FIG. 4 accesses the sharing relationship database 408 to identify sharing target(s) of the query and integrates identifying information associated with the target(s) into the search results. For example, the sharer 412 of FIG. 4 may append a tag to the search results identifying the sharing target(s).

The data files identified in the search results and the target information are then stored in a shared content database 414. Thus, the example shared content database 414 of FIG. 4 includes data files and/or corresponding CIDs meeting criteria of the received isolated and live shared quer(ies). Each data file has identifying information indicative of which user can access the respective data file. The example sharing manager 116 of FIG. 4 also includes a direct interface 416 that enables a user of the data sharing system 100 to manually select a data file (e.g., from the user machines 102, 106 and/or 108) for addition to the shared content database 414. For example, the first user 104 of FIG. 1 may choose to share a particular data file with the second user 110 without having to submit a query. In such instances, the first user 104 utilizes the direct interface 416, which implements a user interface presentable to the first user 104, to add a data file and/or a corresponding CID to the shared content database 414 along with information identifying the second user 110 as a sharing target.

In the illustrated example, the user of the data sharing system 100, such as the second user 110, is provided access to data file(s) in the shared content database 414 for which the user is identified as a sharing target. Thus, the example data sharing system 100 of the illustrated example provides a centralized database of shared content that can be accessed at any time, including times at which the user machines are not reachable and, thus, incapable of providing access to a data file. The user has access to the shared content database 414 via any suitable application and/or interface, such as a web browser, a WebDAV interface, a FUSE file system exported via NFS and/or CIFS, etc. Additionally, the example sharing manager 116 of FIG. 4 includes a publish/subscribe module 418 that pushes content that enters the shared content database 414 with a corresponding target identifier to subscribing users. That is, each time a data file is added to the shared content database 414 that includes the second user 110 as a sharing target, the example publish/subscribe module 418 conveys a notification and/or the data file to the second user 110 (e.g., via an email).

To prevent private data files of the users from being shared via the data sharing system 100, the example sharing manager 116 of FIG. 4 includes a privacy filter 420. The example privacy filter 420 of FIG. 4 checks a privacy content identifier database 422 to determine whether a content identifier associated with a private data file is going to be or already is stored in the shared content database 414. That is, the example privacy content database 422 of FIG. 4 includes CIDs associated with data files that corresponding users do not want to share with other users via the data sharing system 100.

In the illustrated example of FIG. 4, the privacy content identifier database 422 is populated in a plurality of ways. For example, a privacy query may be received at the example query storage interface 400 from the first user 104. The first user 104 submits a privacy query to exclude data files including term(s) and/or phrase(s) from the collection of data to be shared using the data sharing system 100. The privacy query may be an isolated or live query. Live privacy queries are stored in the live privacy query database 404. The search caller 410 facilitates a search of the appropriate user view of the user view database 204 of FIG. 2A when the privacy query is to be executed (e.g., once upon receipt for an isolated query and multiple times for a live query as triggered by the search trigger 411). The search caller 410 receives the results and conveys the results to the privacy content identifier database 422. Thus, live privacy queries can persistently protect current and/or newly added data including term(s) and/or phrase(s) corresponding to private circumstances and/or aspects from being shared. Additionally or alternatively, the first user 104 can utilize the direct interface 416 to manually add CID(s) associated with data file(s) that the first user 104 does not want to share via the data sharing system 100. The example privacy filter 420 of FIG. 4 prevents CIDs of data files found in the privacy content identifier database 422 from being added to the shared content database 414. For example, before the search caller 410 and/or the sharer 412 add sharing results to the shared content database 414 as a results of, for example, a live sharing query, an isolated sharing query, and/or a manual addition via the direct interface 416, the example privacy filter 420 of the illustrated example scans the to-be-added results to ensure that private data is not added to the shared content.

While an example manner of implementing the sharing manager 116 of FIG. 1 has been illustrated in FIG. 4, one or more of the elements, processes and/or devices illustrated in FIG. 4 may be combined, divided, re-arranged, omitted, eliminated and/or implemented in any other way. Further, the example query storage interface 400, the example sharing target identifier 406, the example search caller 410, the example search trigger 411, the example sharer 412, the example direct interface 416, the example publish/subscribe module 418, the example privacy filter 420, and/or, more generally, the example sharing manager 116 of FIG. 4 may be implemented by hardware, software, firmware and/or any combination of hardware, software and/or firmware. Thus, for example, any of the example query storage interface 400, the example sharing target identifier 406, the example search caller 410, the example search trigger 411, the example sharer 412, the example direct interface 416, the example publish/subscribe module 418, the example privacy filter 420, and/or, more generally, the example sharing manager 116 of FIG. 4 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended apparatus or system claims are read to cover a purely software and/or firmware implementation, at least one of the example query storage interface 400, the example sharing target identifier 406, the example search caller 410, the example search trigger 411, the example sharer 412, the example direct interface 416, the example publish/subscribe module 418, the example privacy filter 420, and/or, more generally, the example sharing manager 116 of FIG. 4 are hereby expressly defined to include a tangible and/or non-transitory computer readable medium such as a physical memory, DVD, CD, etc. storing the software and/or firmware. Further still, the example sharing manager 116 of FIG. 4 may include one or more elements, processes and/or devices in addition to, or instead of, those illustrated in FIG. 4, and/or may include more than one of any or all of the illustrated elements, processes and devices.

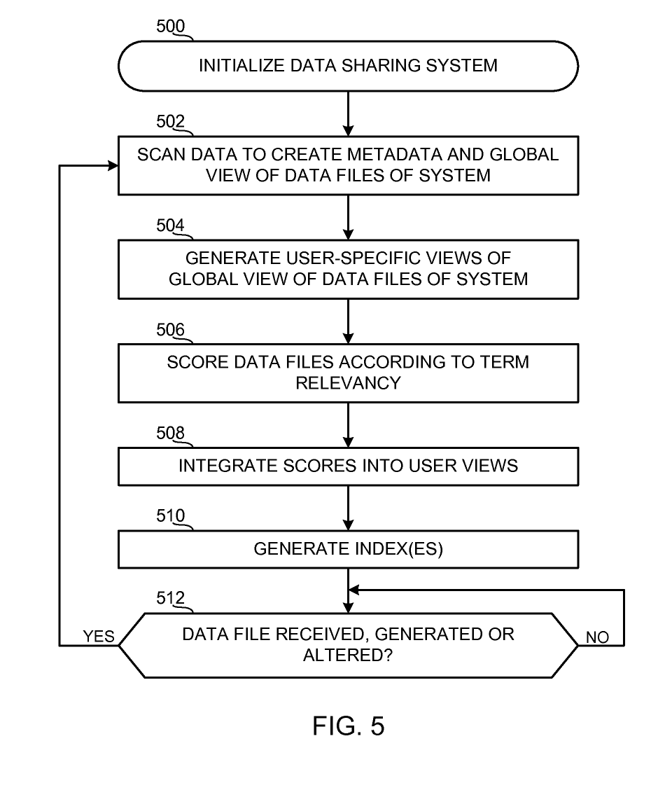

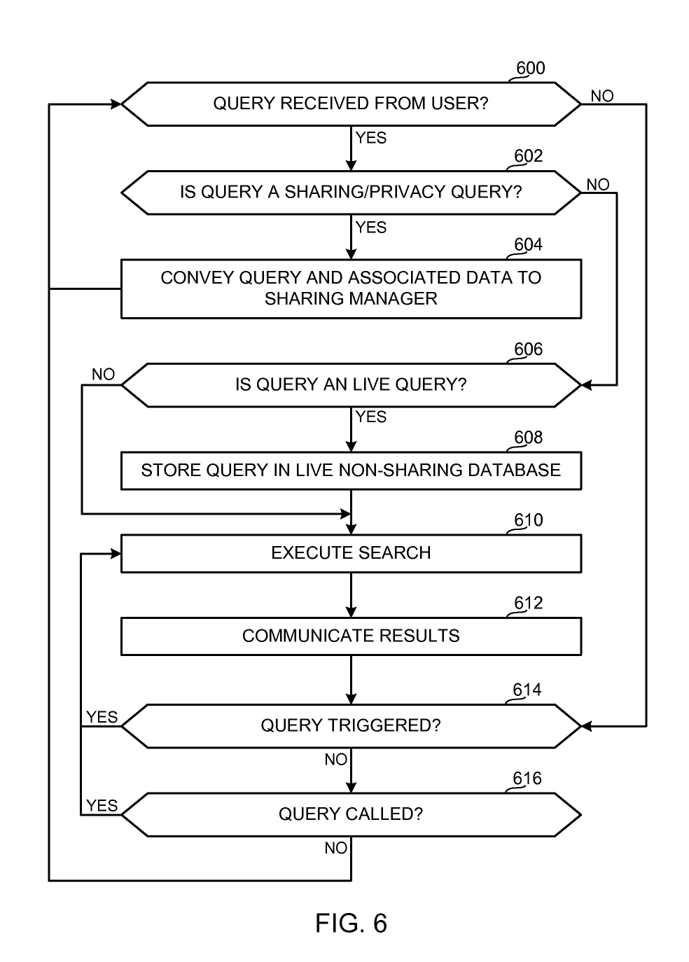

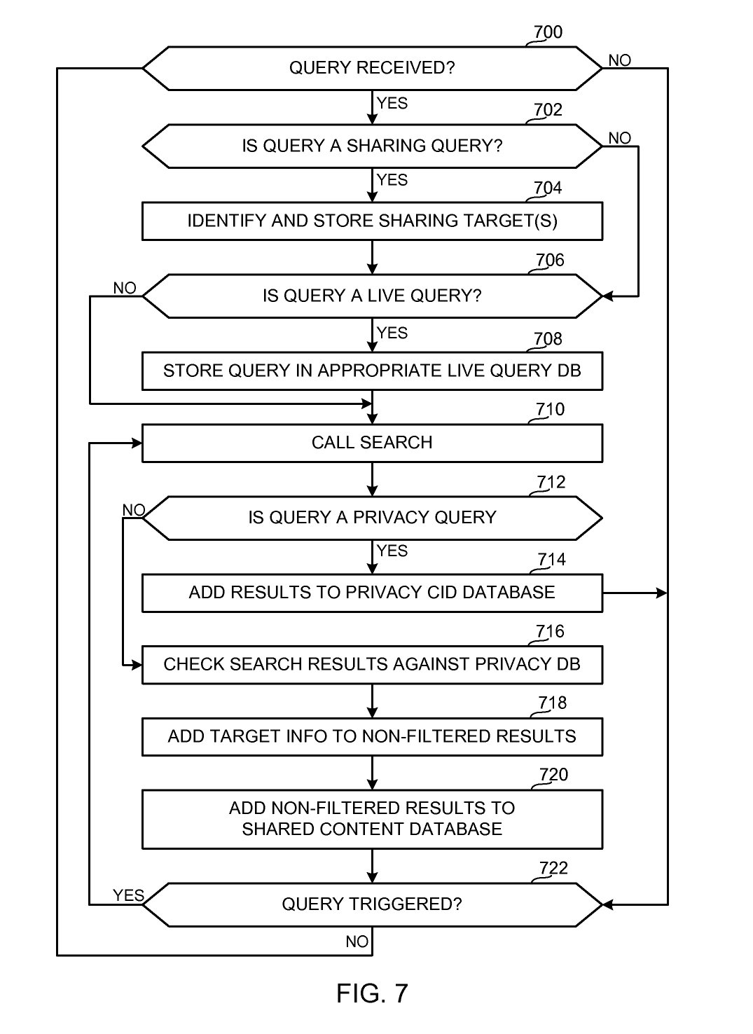

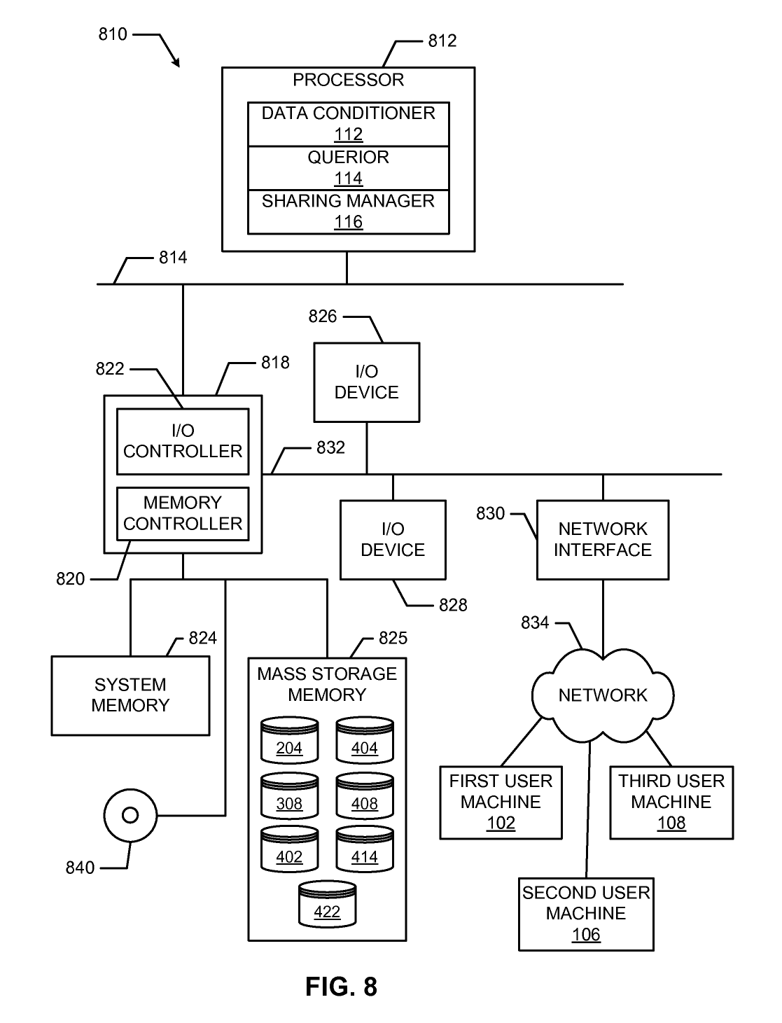

FIG. 5 is a flowchart representative of example machine readable instructions which may be executed to implement the example data conditioner 112 of FIGS. 1 and/or 2. FIG. 5 is described in detail below. FIG. 6 is a flowchart representative of example machine readable instructions which may be executed to implement the example querior 114 of FIGS. 1 and/or 3. FIG. 6 is described in detail below. FIG. 7 is a flowchart representative of example machine readable instructions which may be executed to implement the example sharing manager 116 of FIGS. 1 and/or 4. FIG. 7 is described in detail below. In these examples, the machine readable instructions comprise programs and/or routines for execution by a processor such as the processor 812 shown in the example processor platform 810 discussed below in connection with FIG. 8. The programs may be embodied in software stored on a computer readable medium such as a CD-ROM, a floppy disk, a hard drive, a digital versatile disk (DVD), and/or any form of physical memory associated with the processor 812, but the entire program and/or parts thereof could alternatively be executed by a device other than the processor 812 and/or embodied in firmware or dedicated hardware. Further, although the example programs are described with reference to the flowcharts illustrated in FIGS. 5-7, many other methods of implementing the example data conditioner 112, the example querior 114, and/or the example sharing manager 116 may alternatively be used. For example, the order of execution of the blocks may be changed, and/or some of the blocks described may be changed, eliminated, or combined.

As mentioned above, the example processes of FIGS. 5-7 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 5-7 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

FIG. 5 begins with an initialization of the data sharing system 100 (block 500). The example data scanner 112 scans data of user machines (e.g., the first user machine 102, the second user machine 106, and/or the third user machine 108 of FIG. 1) to create metadata that forms a global view of the data files associated with the data sharing system 100 by way of the user machines (block 502). In the illustrated example, the creation of the metadata includes generating intermediate items (e.g., a reverse_posting_list_by_cid item, a reverse_posting_list_by_term item, and/or a pid_by_cid_with_names item) that reflect certain aspects (e.g., term location and/or frequency) of the data files associated with the data sharing system 100. Using the intermediate items, the example view generator 202 generates user-specific views of the global view of the system 100 (block 504). A user-specific view defines a queryable corpus of data for a user. The generated user views are stored in the user view database 204 of FIG. 2.

The example scorer 206 of FIG. 2A then scores each data file of each user view according to relevancies of terms occurring within a respective data file (block 506). In other words, the example scorer 206 of FIG. 2A determines how frequently each term of a data file occurs in that data file and assigns a score to the data file for each term. The example incorporator 208 of FIG. 2A incorporates the generated scores into the corresponding entries in the user view database 204 (block 508). Further, the example index generator 210 of FIG. 2A generates one or more indexes for one or more of the user views of the database 204 to facilitate searching of the one or more user views (block 510). In the illustrated example, the data conditioner 112 then waits for a data file to be received, generated, or altered on one of the user machines of the data sharing system 100 (block 512). In response to such a change, control passes to block 502. Thus, the example data conditioner 112 maintains a scored and/or indexed queryable corpus of data for each user of the data sharing system 100 (e.g., the first user 104 and the second user 110 of FIG. 1).

FIG. 6 begins with a determination of whether the receiver 300 has received a query (e.g., from the first user 104 of FIG. 1) (block 600). If a query was received from a user at block 600, the designator 302 determines whether or not the received query is a sharing privacy or a privacy query. If the received query is a sharing query or a privacy query (block 602), the query and data associated with the query (e.g., sharing target information) is conveyed to the sharing manager 116 (block 604) and control returns to block 600. In such instances, the sharing manager 116 handles the query as described below in connection with FIG. 7. If the received query is not a sharing query or a privacy query (block 602), the designator 302 determines whether the query is a live query. If the received query is a live query (block 606), the query is stored in the live non-sharing query database 308 (block 608). In the illustrated example, if the query is not a live query (e.g., the query is an isolated query) (block 606), the query is not stored in the live non-sharing database 308. Regardless of whether the query is a live query or not (block 606), the searcher 304 then executes a search of a queryable corpus of data associated with the submitter of the query (block 610). The data files and/or corresponding CIDs are conveyed to the results communicator 306, which communicates the results to the submitter (block 612). Subsequently, a search stored in the live non-sharing query database 308 may be triggered by the search trigger 306 (block 614). If so, control is passed to block 610 and the searcher 304 executes the search. Alternatively, a search stored in the live sharing query database 402 or the live privacy query database 404 may be called by the search caller 410 of FIG. 4 (block 616). If so, control is passed to block 610 and the searcher 304 executes the search. Otherwise, control returns to block 600.

FIG. 7 begins with a determination of whether a query was received at the query storage interface 400 (e.g., from the querior 114 when the designator determines that a received query is a live query or a privacy query) (block 700). If a query was not received (block 700), control passes to block 722. On the other hand, if the query was received (block 700) and the query is a sharing query (block 702), the example sharing target identifier 406 identifies sharing target(s) of the query and stores a corresponding entry in the sharing relationship database 408 (block 704). If the query is not a sharing query (e.g., the query is a privacy query) (block 702), the identification and storage of the sharing target(s) at block 704 is bypassed.

If the query is a live query (block 706), query storage interface 400 facilitates storage of the query in the live sharing query database 402 (block 708). If the query is not a live query (block 706) (e.g., the query is an isolated query), the storage of the query at block 708 is bypassed. The search caller 410 then calls a search function implemented by the searcher 304 of FIG. 3 (block 710). As described above, the searcher 304 executes a search and returns results to the search caller 410. If the query is a privacy query (block 712), CIDs associated with the search results are added to the privacy content identifier database 422 and control passes to block 722 (block 714). On the other hand, if the query is not a privacy query (block 712), control passes to block 716 and the privacy filter 420 compares CIDs of the search results to the CIDs of the privacy content identifier database 422 to determine whether any of the search results should be restricted from being shared via the data sharing system 100 (block 716). Any matches are filtered out from the search results and the sharer 412 adds the sharing target information from the sharing relationship database 408 to the search results (block 718). The non-filtered results are then added to the shared content database 414 (block 720). The search trigger 411 can subsequently trigger a search (block 722), which passes control to block 710. Otherwise, control passes to block 700.

FIG. 8 is a block diagram of an example processor system 610 that may be used to execute the machine readable instructions of FIGS. 5-7 to implement the example data sharing system 100 of FIGS. 1-4. The example processor system 810 of FIG. 8 includes a processor 812 that is coupled to an interconnection bus 814. The processor 812 may be any suitable processor, processing unit, or microprocessor (e.g., one or more Intel® microprocessors from the Pentium® family, the Itanium® family or the XScale® family and/or other processors from other families). The system 810 may be a multi-processor system and, thus, may include one or more additional processors that are identical or similar to the processor 812 and that are communicatively coupled to the interconnection bus 814. In the illustrated example of FIG. 8, the processor 612 implements the data conditioner 112, the querior 114, and the sharing manager 116.

The processor 812 of FIG. 8 is coupled to a chipset 818, which includes a memory controller 820 and an input/output (I/O) controller 822. A chipset provides I/O and memory management functions as well as a plurality of general purpose and/or special purpose registers, timers, etc. that are accessible or used by one or more processors coupled to the chipset 818. The memory controller 820 performs functions that enable the processor 812 to access a system memory 824, a mass storage memory 825, and/or a digital versatile disk (DVD) 840. In the illustrated example of FIG. 8, the mass storage memory 825 includes the user views database 204, the live non-sharing query database 308, the live sharing query database 402, the live privacy query database 404, the sharing relationship database 408, the shared content database 414, and the privacy content identifier database 422. However, one or more of the databases 204, 308, 402, 404, 408, 414, and/or 422 can be stored in alternative location(s) or memor(ies) associated with the example processor system 810 of FIG. 8.

In general, the system memory 824 may include any desired type of volatile and/or non-volatile memory such as, for example, static random access memory (SRAM), dynamic random access memory (DRAM), flash memory, read-only memory (ROM), etc. The mass storage memory 825 may include any desired type of mass storage device including hard disk drives, optical drives, tape storage devices, etc. The machine readable instructions of FIGS. 5-7 may be stored in the system memory 824, the mass storage memory 825, and/or the DVD 840.

The I/O controller 822 performs functions that enable the processor 812 to communicate with peripheral input/output (I/O) devices 826 and 828 and a network interface 830 via an I/O bus 832. The I/O devices 826 and 828 may be any desired type of I/O device such as, for example, a keyboard, a video display or monitor, a mouse, etc. The network interface 830 may be, for example, an Ethernet device, an asynchronous transfer mode (ATM) device, an 802.11 device, a digital subscriber line (DSL) modem, a cable modem, a cellular modem, etc. that enables the processor system 810 to communicate with another processor system. The example network interface 830 of FIG. 8 is also communicatively coupled to a network 834, such as an intranet, a Local Area Network, a Wide Area Network, the Internet, etc. In the illustrated example of FIG. 8, the first, second and third user machines 102, 106, and 108, respectively, of FIG. 1 are communicatively coupled to the network interface 830 via the network 834.

While the memory controller 820 and the I/O controller 822 are depicted in FIG. 8 as separate functional blocks within the chipset 818, the functions performed by these blocks may be integrated within a single semiconductor circuit or may be implemented using two or more separate integrated circuits.

Although certain example apparatus, system, methods, and articles of manufacture have been disclosed herein, the scope of coverage of this patent is not limited thereto. On the contrary, this patent covers all apparatus, system, methods, and articles of manufacture fairly falling within the scope of the claims of this patent.

1. A data sharing method, comprising:
providing, using a logic circuit, access to a first file associated with a first user to a second user different from the first user via a shared content database;
identifying a second file associated with the first user in response to a privacy query submitted by the first user, wherein the privacy query includes an indication that access to results of the privacy query via the shared content database is to be restricted; and
prohibiting, using the logic circuit, a third user from accessing the second file via the shared content database.

2. A method as defined in claim 1, wherein prohibiting the third user from accessing the second file comprises filtering the second file from search results to be added to the shared content database.

3. A method as defined in claim 2, further comprising re-executing the privacy query in response to a triggering event and filtering results of the re-executed privacy query from the shared content database.

4. A method as defined in claim 2, wherein the shared content database is a centralized component of a data sharing system.

5. A method as defined in claim 1, further comprising identifying the second user as a sharing target associated with a sharing query.

6. A method as defined in claim 5, further comprising establishing a sharing relationship between the first and second users according to the identification of the second user as the sharing target.

7. A method as defined in claim 1, wherein providing access to the first file to the second user comprises associating data corresponding to the second user with a database entry corresponding to the first file.

8. A data sharing system, comprising:
a sharing manager to identify a first file in response to a first query submitted by a first user and to provide access to the first file to a second user different from the first user via a shared content database; and
a privacy filter to:
identify a second file associated with the first user in response to a second query submitted by the first user, wherein the second query includes an indication that access to results of the second query via the shared content database is to be restricted; and
to prohibit a third user from accessing the second file via the shared content database.

9. A data sharing system as defined in claim 8, wherein the privacy filter is to prohibit the third user from accessing the second file by filtering the second file from search results to be added to the shared content database.

10. A data sharing system as defined in claim 9, further comprising a querior to re-execute the second query in response to a triggering event, the privacy filter is to filter results of the re-executed second query from the shared content database.

11. A data sharing system as defined in claim 9, wherein the shared content database is a centralized component of a data sharing system.

12. A data sharing system as defined in claim 8, further comprising a sharing target identifier to identify the second user as a sharing target associated with the first query.

13. A data sharing system as defined in claim 12, wherein the sharing manager includes a sharer to establish a sharing relationship between the first and second users according to the identification of the second user as the sharing target.

14. A data sharing system as defined in claim 8, wherein the sharing manager provides access to the first file to the second user by associating data corresponding to the second user with a database entry corresponding to the first file.

15. A tangible machine readable storage medium comprising instructions that, when executed, cause a machine to at least:
obtain a first file identified in connection with a first query of a first type submitted by a first user;
provide access to the first file via a shared content database to a second user different from the first user;
obtain a second file identified in connection with a second query of a second type submitted by the first user, wherein queries of the second type include an indication that access to results of the corresponding query via the shared content database is to be restricted; and
prohibit the second user from accessing the second file via the shared content database.

16. A storage medium as defined in claim 15, wherein the instructions cause the machine to prohibit the second user from accessing the second file by filtering the second file from search results to be added to the shared content database.

17. A storage medium as defined in claim 16, wherein the instructions are to cause the machine to re-execute the second query in response to a triggering event and to filter results of the re-executed second query from the shared content database.

18. A storage medium as defined in claim 16, wherein the shared content database is a centralized component of a data sharing system.

19. A storage medium as defined in claim 15, wherein the instructions are to cause the machine to identify the second user as a sharing target associated with the first query.

20. A storage medium as defined in claim 19, wherein the instructions are to cause the machine to establish a sharing relationship between the first and second users according to the identification of the second user as the sharing target.
